(19) United States
(12) Patent Application Publication
(10) Pub. No.: US 2025/0162833 A1
(43) Pub. Date: May 22, 2025

(54) ARTICULATING DIE AND FORMING PROCESS

(71) Applicant: Foldstar Inc., Hamilton, NJ (US)

(72) Inventor: Daniel Kling, Doylestown, PA (US)

(21) Appl. No.: 18/886,881

(22) Filed: Sep. 16, 2024

Related U.S. Application Data
(60) Provisional application No. 63/583,136, filed on Sep. 15, 2023.

(51) Int. Cl. B65H 45/12; B30B 15/02

(52) U.S. Cl. CPC B65H 45/12; B30B 15/02

(57) ABSTRACT

Devices and methods for configuring an articulating die to form a material into desired tessellations are disclosed, including providing articulating lever arms affixed to geometrically shaped tiles in a predetermined configuration such that application of force to the lever arms will generate a desired pattern of peak and valley folds in the material to achieve a desired shape. The material may further be shaped by tools corresponding to desired characteristics.

### CROSS-REFERENCE TO RELATED APPLICATIONS

This application claims priority to U.S. Provisional Application Ser. No. 63/583,136, filed on Sep. 15, 2023, which is incorporated by reference herein.

### FIELD OF THE INVENTION

The invention relates generally to an articulating die that may be used in a press to fold sheet materials, and methods of folding sheet materials.

### BACKGROUND OF THE INVENTION

Folded tessellations are valuable for many applications, including as structural core materials, sound absorbing materials, architectural panels, energy absorbing materials for packaging and transportation, and many other applications. Folded tessellations may be fabricated from a diverse range of materials, including papers, metals, fiber composites, plastics, woven and non-woven composites, and any material that folds. Folding is an unusual forming process in that the sheet material undergoes very little in-plane deformation. For contrast, stamping or thermoforming generally requires significant strain. Another interesting phenomenon when folding tessellations is that due to the many directions of fold crease lines the material will generally contract in the top view from both horizontal directions. Together these properties of folding present fabrication challenges that have traditionally limited the state of the art. In particular, conventional presses and dies are not suitable to fold tessellations.

### SUMMARY OF THE INVENTION

It is one aspect of some embodiments of the present invention to provide a method for forming a structural cellular core. In another aspect the present invention provides an articulating die with moving components that folds sheet material into a tessellation structure by transferring force applied to the die into a resulting folding action on the material. In another aspect material is placed between two dies, each die having lever arms and hinging, and by applying force to the dies the force induces a folding action on the material. In one variation sheet material is loaded into mating articulating dies, the dies and material are positioned between two plates of a press, and the pressing action actuates the articulation of the dies and folds the material. In another embodiment the actuation of the dies may further cause the material to contract laterally in the two sheet directions as the material is folded into in a tessellation pattern. In one variation after folding, the sheets may be laminated between face sheets to produce a structural panel. In yet another variation, an articulating die may be constructed with hinging following the folding architecture of a folding tessellation, and having a mechanical system on the back of the die with mechanical components that readily transfer force to the folding action of the die.

The Summary of the Invention is neither intended nor should it be construed as being representative of the full extent and scope of the present invention. That is, these and other aspects and advantages will be apparent from the disclosure of the invention(s) described herein. Further, the above-described embodiments, aspects, objectives, and configurations are neither complete nor exhaustive. As will be appreciated, other embodiments of the invention are possible using, alone or in combination, one or more of the features set forth above or described below. Moreover, references made herein to “the present invention” or aspects thereof should be understood to mean certain embodiments of the present invention and should not necessarily be construed as limiting all embodiments to a particular description. The present invention is set forth in various levels of detail in the Summary of the Invention as well as in the attached drawings and the Detailed Description and no limitation as to the scope of the present invention is intended by either the inclusion or non-inclusion of elements, components, etc. in this Summary of the Invention. Additional aspects of the present invention will become more readily apparent from the Detailed Description, particularly when taken together with the drawings.

The above-described benefits, embodiments, and/or characterizations are not necessarily complete or exhaustive, and in particular, as to the patentable subject matter disclosed herein. Other benefits, embodiments, and/or characterizations of the present invention are possible utilizing, alone or in combination, as set forth above and/or described in the accompanying figures and/or in the description herein below.

The phrases “at least one,” “one or more,” and “and/or,” as used herein, are open-ended expressions that are both conjunctive and disjunctive in operation. For example, each of the expressions “at least one of A, B and C,” “at least one of A, B, or C,” “one or more of A, B, and C,” “one or more of A, B, or C,” and “A, B, and/or C” means A alone, B alone, C alone, A and B together, A and C together, B and C together, or A, B and C together.

Unless otherwise indicated, all numbers expressing quantities, dimensions, conditions, and so forth used in the specification and drawing figures are to be understood as being approximations which may be modified in all instances as required for a particular application of the novel assembly and method described herein.

The term “a” or “an” entity, as used herein, refers to one or more of that entity. As such, the terms “a” (or “an”), “one or more” and “at least one” can be used interchangeably herein.

The use of “including,” “comprising,” or “having” and variations thereof herein is meant to encompass the items listed thereafter and equivalents thereof as well as additional items. Accordingly, the terms “including,” “comprising,” or “having” and variations thereof can be used interchangeably herein.

### BRIEF DESCRIPTION OF THE DRAWINGS

The accompanying drawings, which are incorporated in and constitute a part of the specification, illustrate embodiments of the invention and together with the general description of the invention given above and the detailed description of the drawings given below, serve to explain the principles of these inventions.

FIG. 1 shows a drawing of an articulating die with lever arms attached where the lever arms have wheel skids and the assembly articulates according to the chevron folding tessellation.

FIG. 2 shows a drawing of the articulating die similar to FIG. 1 in a partially folded state.

FIG. 3 shows a drawing of the articulating die similar to FIG. 2 in a further folded state.

FIG. 4 shows a drawing of the articulating die similar to FIG. 3 in a yet further folded state.

FIG. 5A shows a close-up of the lever arm similar to FIG. 1.

FIG. 5B shows the lever arm over a folding tile similar to FIG. 1 with a tangent horizontal plane and normal vertical line indicated.

FIG. 6A shows a drawing of an articulating die similar to FIG. 1 with a sliding lever arm.

FIG. 6B shows a drawing of the articulating die similar to FIG. 6A in a partially folded state.

FIG. 7A shows a schematic drawing of a lever arm on a folding articulating die in the unfolded state.

FIG. 7B shows a schematic drawing of a lever arm on a folding articulating die similar to FIG. 7A in a partially folded state.

FIG. 7C shows a schematic drawing of a lever arm on a folding articulating die similar to FIG. 7A in a maximally folded state.

FIG. 8 shows a schematic drawing of lever arms similar to FIG. 7A on both an upper and lower folding articulating die through a progression of folding states with horizontal tangent planes indicated.

FIG. 9 shows a schematic drawing of a folded surface with fold radius at each fold crease that may be produced by articulating dies similar to FIG. 4.

FIG. 10 shows a drawing of a mold tool with a form approximately similar to FIG. 9 with flat plateaus and flat valley regions.

FIG. 11 shows a drawing of a part produced by a forming process in a tool similar to FIG. 10.

FIG. 12 shows a drawing of an articulating die with lever arms attached where the assembly articulates according to a folding tessellation with rectangular and parallelogram tiles.

FIG. 13 shows a drawing of upper and lower articulating dies similar to FIG. 12, with sheet material positioned between the articulating dies in expectation of being folded.

FIG. 14 shows the articulating dies FIG. 13 brought together to clamp the sheet material.

FIG. 15 shows a drawing the articulating dies and sheet material in FIG. 14 with the dies actuated into a folded state.

FIG. 16 shows a drawing the articulating dies and sheet material in FIG. 15 with the dies separated to reveal the folded sheet material.

FIG. 17 shows a drawing of the folded sheet material of FIG. 16.

FIG. 18 shows a drawing of the folded sheet material of FIG. 17 folded to a further state.

FIG. 19 shows a drawing of the folded sheet material with a folding tessellation pattern.

FIG. 20 shows a drawing of the folded sheet material of FIG. 19 reshaped into a doubly curved pattern.

FIG. 21 shows a drawing of the folded sheet material of FIG. 20 form fit on a tool.

FIG. 22 shows a drawing of the tool of FIG. 20 as it begins to engage the folded material to compress it.

FIG. 23 shows a schematic drawing of the folded sheet material of FIG. 22 fully compressed into smooth surface.

FIG. 24 shows a picture of a thermoplastic felt that has been folded and heat set in a folded state.

FIG. 25 shows a picture of a core materials made from a natural fiber composite with a thermoplastic binder that has been folded in an articulating die, then pressed with heated dies to incorporate additional features to the folded state, and then laminated between two face sheets.

It should be understood that the drawings are not necessarily to scale. In certain instances, details which are not necessary for an understanding of the invention or which render other details difficult to perceive may have been omitted. It should be understood, of course, that the invention is not necessarily limited to the particular embodiments illustrated herein.

### DETAILED DESCRIPTION

In one embodiment of the present invention, a die is provided with multiple hinges that enable articulation of the die during the forming process. The hinges may be positioned to imitate the folding lines of the folding tessellation. The collective effect of multiple hinges folding simultaneously enables the die to move analogously to a folding tessellation. In one embodiment the die or a surface side of the die articulates in close approximation to a folding tessellation. In one embodiment by affixing a sheet of material to the die surface, or by using two dies from opposing sides of the sheet material, the material can then be corralled into following the surface trajectories of the die and itself fold as a folding tessellation.

In one embodiment, the hinging in the die may have steel leaves with a steel pin, or steel alloys or other high-temperature materials so that the die may be heated to assist in the folding of certain materials such as thermoplastics. In one embodiment, the polygons of the tessellation give the approximate sizes of panels used in construction of the die between the hinging. The panels are may also be called tiles, due to their layout in the tessellation pattern. In one embodiment the panels may be cut from steel or other stiff material, and an offset from the polygon size of the desired folded tessellation calculated, to accommodate for the added spacing of the hinges and their pins. In another embodiment, the hinge layout and hinge leaf arrangement may be designed so that when the die is in the unfolded flat state, the pins of the hinges will substantially lie in one common plane. This may assist in articulation of the die without binding. In another embodiment, it is preferred that the hinges are attached to the tiles of the die with spot welding or other technique that has minimal protrusion into the surface planes of the contact side of the die. This low relief profile is preferred in some embodiments for providing a smooth face for contacting the sheet to be folded. In another embodiment, it is preferred that the pins lie close to the contact side of the die, so that the folding axis are close to the material and the articulation geometry of the die closely imitates the folding tessellation geometry of the material.

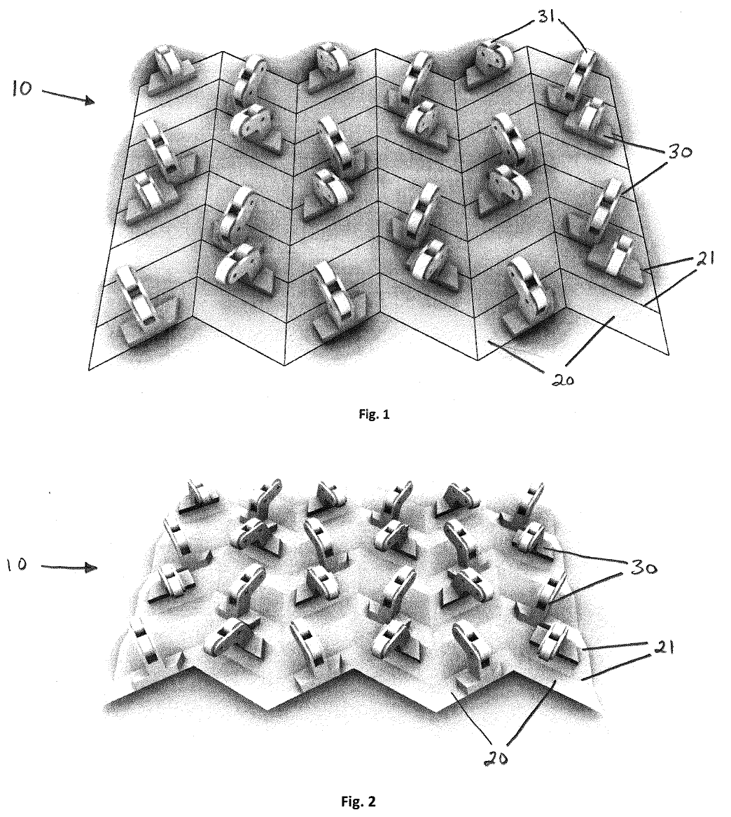

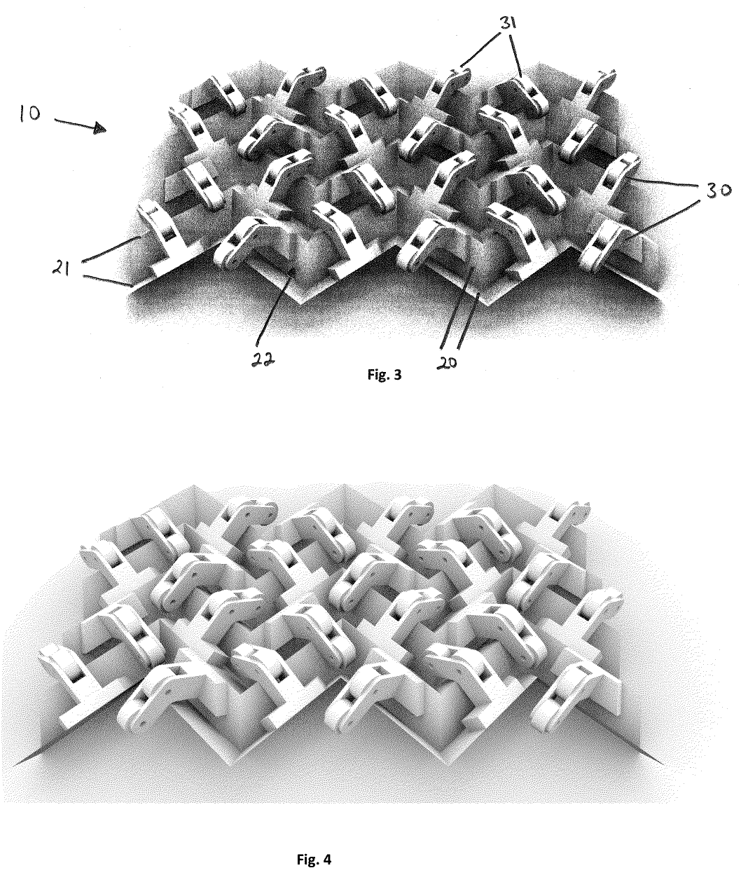

FIG. 1 depicts one embodiment of an articulating die according to the present invention. In FIG. 1, the parallelogram tiles (20) are arranged in a chevron pattern. In this embodiment, hinges (21) may be attached to the tiles along their edges, so that the structure folds as a chevron tessellation. In preferred embodiments, the tiles have sufficient stiffness to fold material held close to the underside of the die. In the figure, lever arms (30) are shown attached to selected tiles. In FIGS. 2, 3, and 4, the die is seen articulating through progressively folded states. It may be seen that for each tile with attached lever arm, the lever arm extends over to the valley side (22) of its attached tile. In FIG. 1, the extension of the lever arm over the valley crease means that by pushing down on the lever arm, a leveraged effect induces the attached file to tip over. Due to the interconnectedness of the many fold hinges and the algebraic solution to the hinge system, a downward force on the system of lever arms will actuate the folding of the die through the combined tipping action distributed on the lever arms and their attached tiles. In one embodiment, a downward force is applied to each of the lever arms simultaneously by a horizontal plate. In yet a further embodiment the lever arms are greased to slide on the plate. In an embodiment suggested by FIGS. 1, 2, 3, and 4, the lever arm may have bearings or wheels (31) at the contact points with the plate to reduce friction. In another embodiment the wheels or bearings (31) may be replaced with skid surfaces, which may optionally be coated to reduce friction, or may optionally be plated with or made out of a material that has a relatively lower coefficient of friction. In a preferred embodiment the lever arms are coated with Teflon or similar coating.

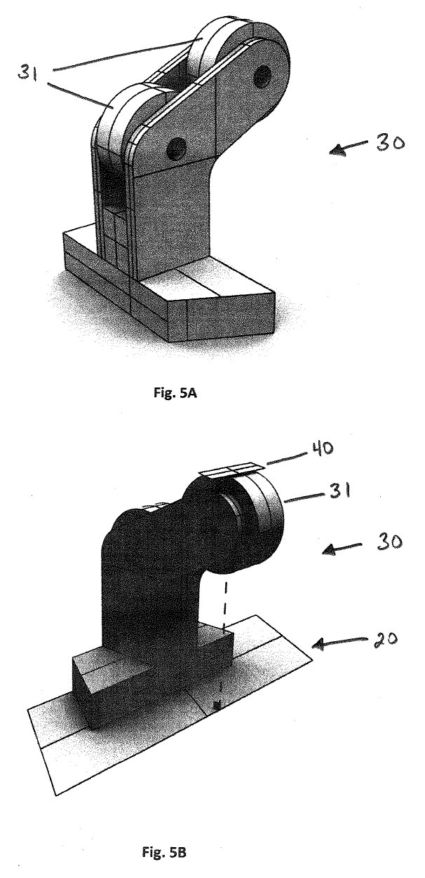

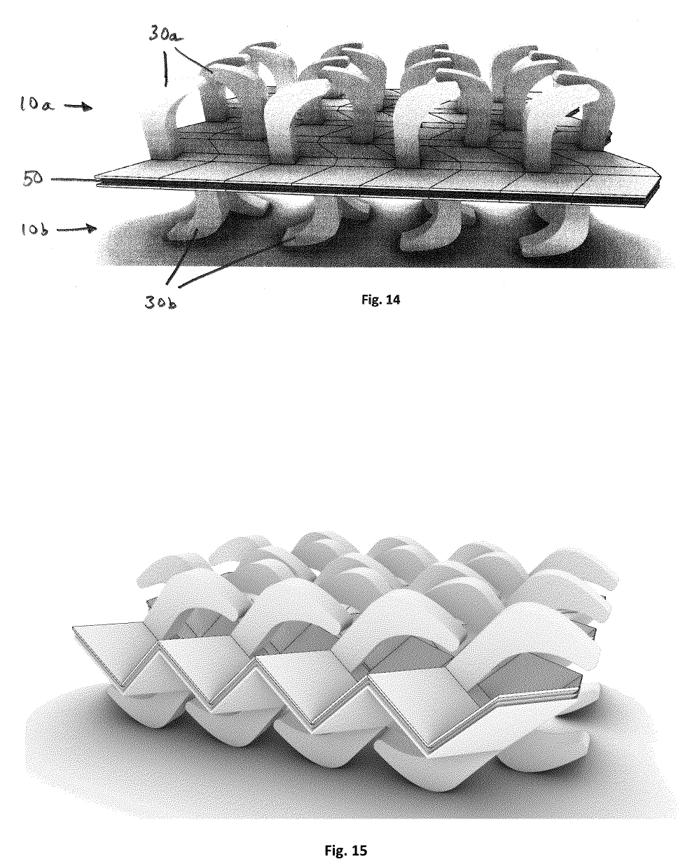

FIG. 5A shows a close-up of a wheeled lever arm (30) used in one embodiment. FIG. 5B shows the same lever arm (30), attached to a tile (20), with a reference horizontal plane (40) tangent to its top wheel (31). A dashed line is drawn showing the normal from the tangent plane at the point of tangency. In another embodiment the lever arm would cantilever out past the valley edge, and the normal line would be beyond the edge of the tile. In this case a downward force on the wheel would cause tile to pivot on its valley edge. If two mating dies are arranged facing each other as in FIG. 14, compressive force would induce the tiles to pivot near their center axis between the valley and ridge folds.

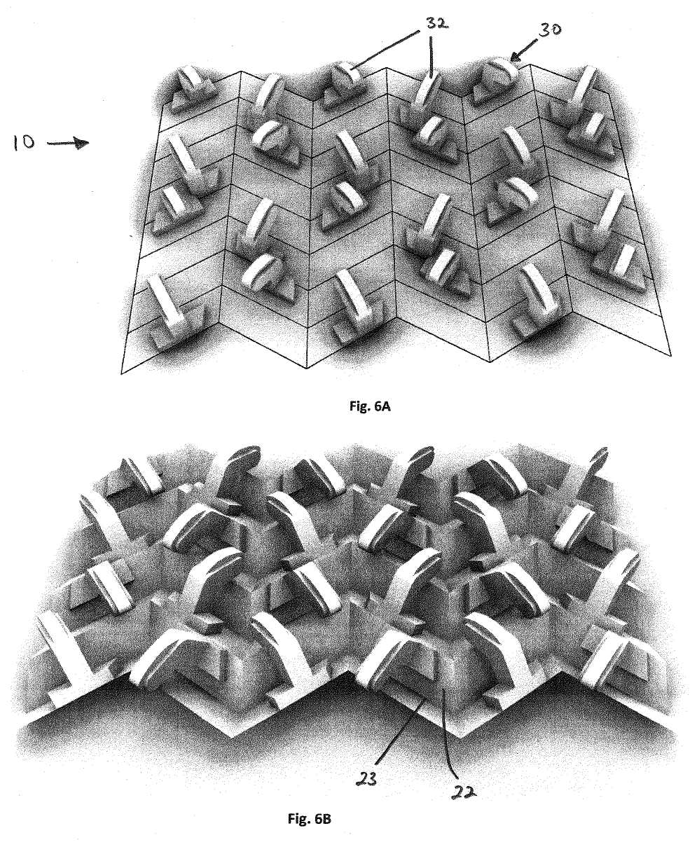

FIG. 6A and 6B show another embodiment of an articulating die (10) with a lever arm (30) with curved skid (32). In the unfolded state, preferably the tangent point on the skid is over the valley side (22) and beyond the midpoint of the tile (20). As it folds, the tangent point moves along the curve of each skid, all the while remaining on or beyond the valley fold (23). In this way force may be transferred from a compressive plate to the lever arm and continues to actuate the folding process as the levers turn.

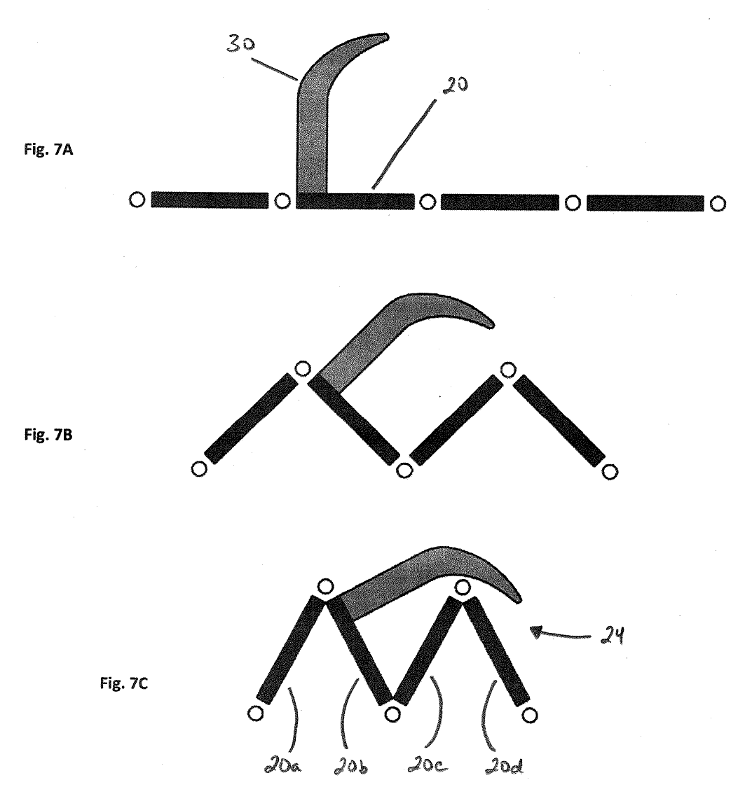

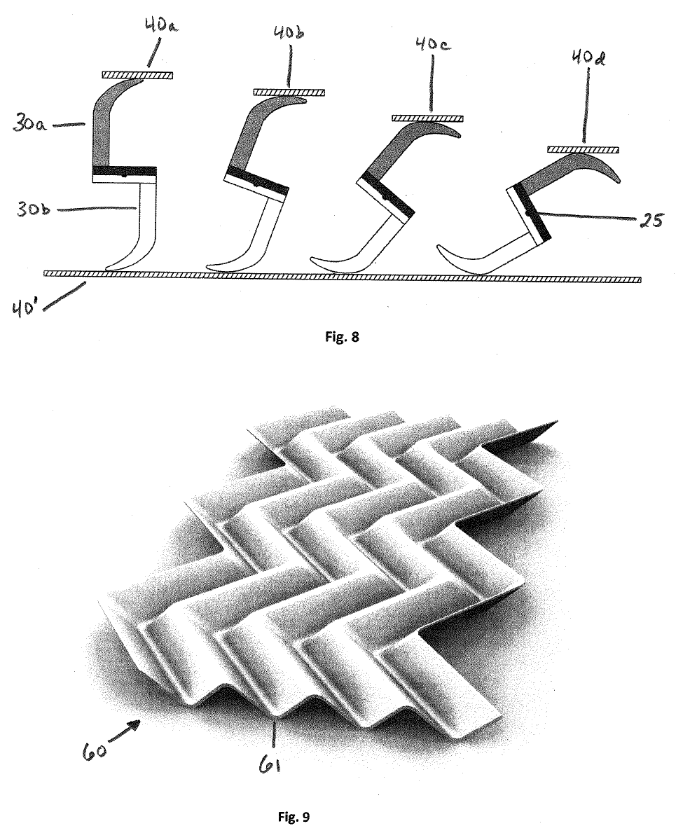

In another embodiment the normal line from the tangent plane of the lever arm (30) may reach beyond the center line of the tile (20). In FIG. 7A, a lever arm (30) is drawn schematically. Its tangent point lies above the tile (20) and beyond the center line of the tile (20). As the system folds the lever arm moves with the folding tiles (20), as depicted schematically, for example, in FIG. 7B. In this embodiment, in the fully folded state, the lever arm (30) on one tile (20b) folds into the cavity (24) beyond the next tile (20c), as seen in FIG. 7C. Depending on how steeply inclined the tiles (20) are in the fully folded state, in various embodiments the lever arms (30) may reach over multiple tiles (20) in the fully folded state.

It is further desirable in yet another embodiment, for the geometry of the lever arms (30) to be such that when reversed back-to-back from an upper die and a lower die as shown in FIG. 8, that the tangent horizontal planes (40a-d) of the upper (30a) and lower (30b) lever arms become closer and closer together as the two arms articulate in the folding process. This may be seen in the figure, for as the upper and lower tile/arm assemblies turn clockwise moving through the four frames left to right, the upper tangent plane (40) drops closer to the lower tangent plane (40′). The figure has a black dot (25) representing the midline of the upper and lower tiles. It is preferred that in each folded state, the tangent point of the lever arms extend beyond the midline of the tile (25; black dot). In this way the rotating of the tiles about the dot decreases the distance between the tangent planes (40, 40′). In this embodiment, the downward force of tangent plates will induce the global folding action.

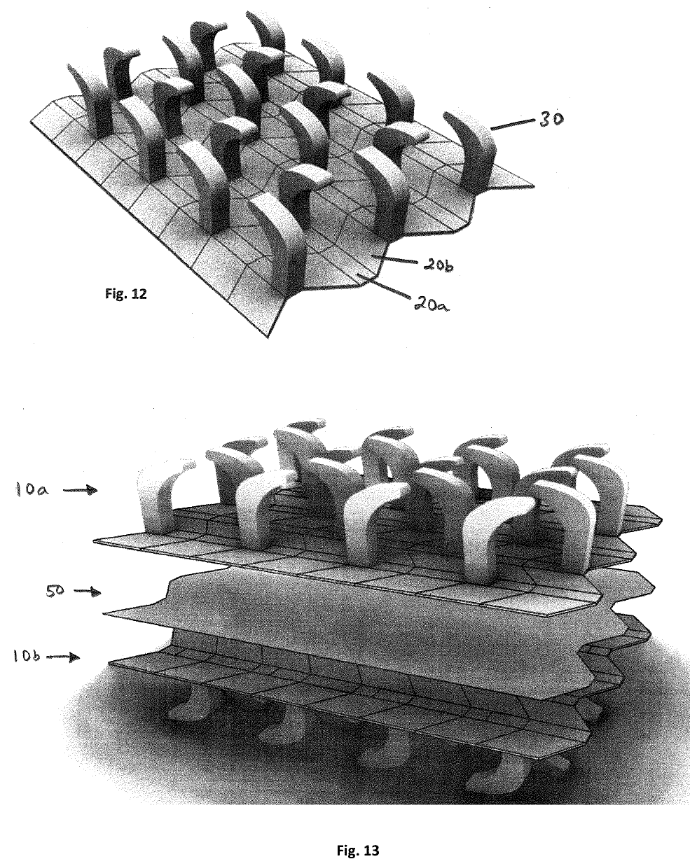

In one embodiment, an articulating die can be fabricated to resemble a folding tessellation with both rectangular and parallelogram tiles. FIG. 12 shows a drawing of a die pattern with both rectangular (20a) and parallelogram (20b) tiles. In yet another embodiment, lever arms may be attached to a subset of the tiles. Note in FIG. 12 the lever arms (30) are attached to only the rectangular tiles (20a), and to only half of them. One of ordinary skill in the art will appreciate that the precise configuration of the lever arms and the size, shape, and layout of the tiles may be varied to achieve the desired tessellation. From the ridge and valley convexities of the resulting tessellation seen in FIG. 15, it is seen that the backs of the lever arms (30) are aligned near the ridge folds, and the arms extend out over the valley folds. In one embodiment, arms extend in opposite directions on the die, and, optionally, the arms are attached to the same shape tile. For example, as shown in FIG. 13, the arms form columns that alternate one column facing toward the left and the next column facing toward the right, and yet the back of each arm is equidistant from its ridge fold. In one embodiment, the lever arms are attached to a subset of tiles and the attachment regions all have the same symmetry relative to the folded tessellation geometry. For example, in the embodiment depicted in FIG. 12 and FIG. 15, each attached rectangle positions can be translated and rotated consistent with the symmetries of the folded surface to the locations of the other attached rectangle positions.

In one embodiment an upper and lower die (10a, 10b) are positioned so that their smoother sides face each other, and material (50) is positioned between them. An example is shown in FIG. 13. The dies may be pressed together as shown in FIG. 14 to substantially clamp the material (50) between them. It yet a further embodiment, the lever arms (30a) of the upper die (10a) extend out toward its valley folds, and the lever arms (30b) of the lower die (10b) extend out under the upper die's ridge folds. This may be seen, for example, in FIG. 15. In an embodiment, a force is applied to the lever arms of the upper die and lever arms of the lower die to induce the folding action. In yet a further embodiment, the force may be applied to mechanisms on the backs of the upper and lower dies to press them together. In yet a further embodiment, the force may be applied through pressure plates to mechanisms on the backs of the upper and lower die to press them together while they articulate in a folding action. Note the distance between the tangent upper plane and the tangent lower plane of FIG. 14 is greater than the distance between the tangent upper plane and the tangent lower plane in FIG. 15 due to geometry considerations similar to those described in FIG. 8. This aspect is an example of yet another embodiment, where the upper and lower dies are constructed with mechanisms on their backs that move during the folding process so that the upper and lower tangent planes become closer together as the dies articulate in the folding process.

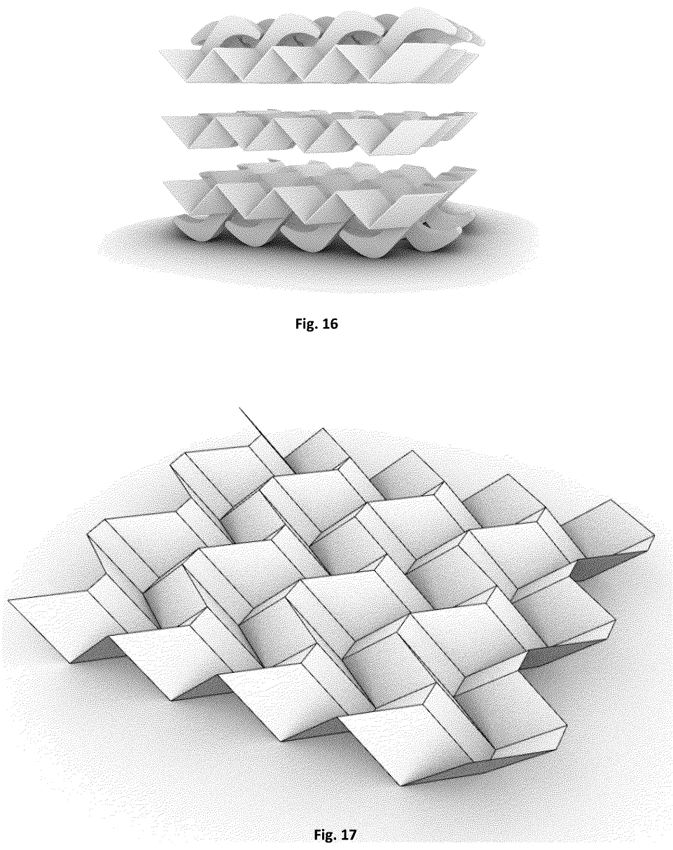

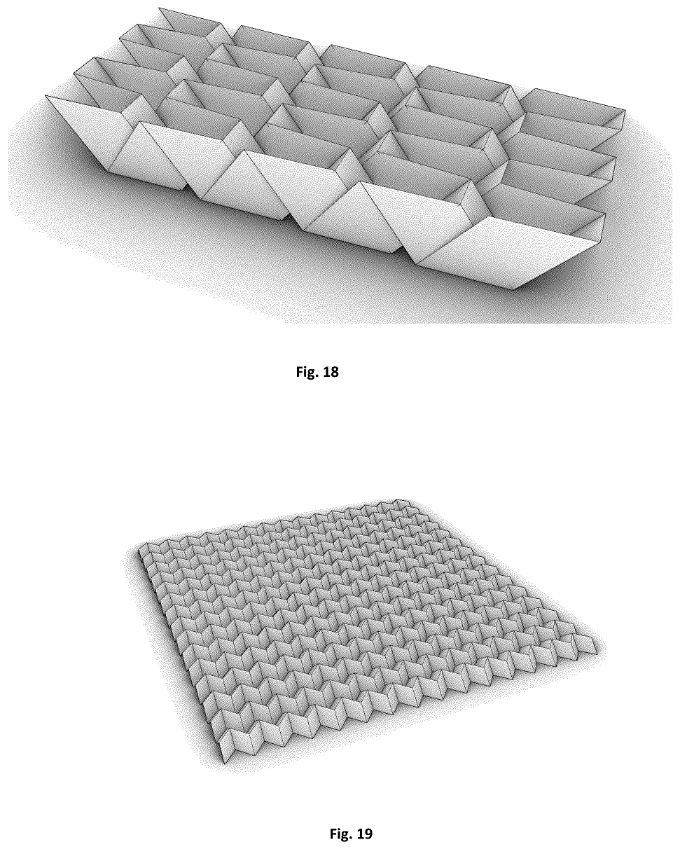

In one embodiment the sheet material positioned between the mating articulating dies of FIG. 13 is fixtured to the die faces as in FIG. 14, folded with the die articulation as in FIG. 15, separated from the dies as in FIG. 16, with resulting folded structure as in FIG. 17. Additional operations may be applied to the folded sheet after removing from the articulating dies. In one embodiment the material of FIG. 17 is compressed laterally after removing from the dies to yield a structure as seen in FIG. 18.

The application of an articulating die to folding tessellation materials may be done in conjunction with thermoset and thermoplastic processes. For example, in one embodiment, fibered non-wovens and cloths may be folded with a resin application and cured in the folded state. Further embodiments include: applying the resin to the material before folding, folding it wet, and then curing it; folding a prepreg material and then curing it; and folding the fiber material and applying the resin after folding it. The last embodiment may use vacuum infusion. In yet further embodiments, the folded materials with release films or agents may be cured in a tool. This may offer opportunity for repeatability and precision, and in some embodiments the opportunity to refine the folding pattern slightly within the deformation tolerance of the material. In this last case the final geometry of the formed part will approximate a folded geometry. In yet a further embodiment there is a folded geometry, an intermediary geometry, and a formed geometry. The folded geometry is produced by a folding tessellation process. The intermediary geometry may be produced by bending, twisting, or applying force to the folded geometry in such a way as to manipulate the overall shape of the sheet material without inducing significant in-plane strain in the material. One may also optionally use the folded geometry without change for the intermediary geometry. The formed geometry is obtained by pressing the intermediary geometry in a mold or tool, and curing it if necessary. There may be in-plane deformation or crumpling during the forming step, but the strain will be within the tolerances of the material. For a point X in the intermediary geometry and its location Y in the formed geometry, X and Y will be within distance d of each other, where d depends on the pattern chosen and forming tool. In yet a further embodiment d is less than the longest polygon diameter in the folding tessellation:

|X−Y|<d

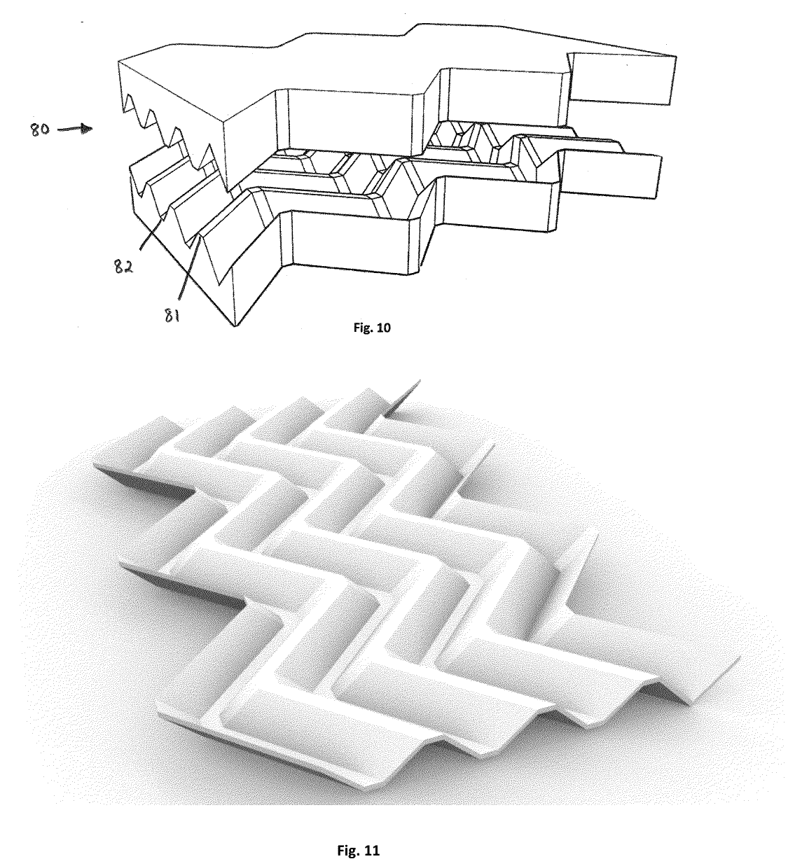

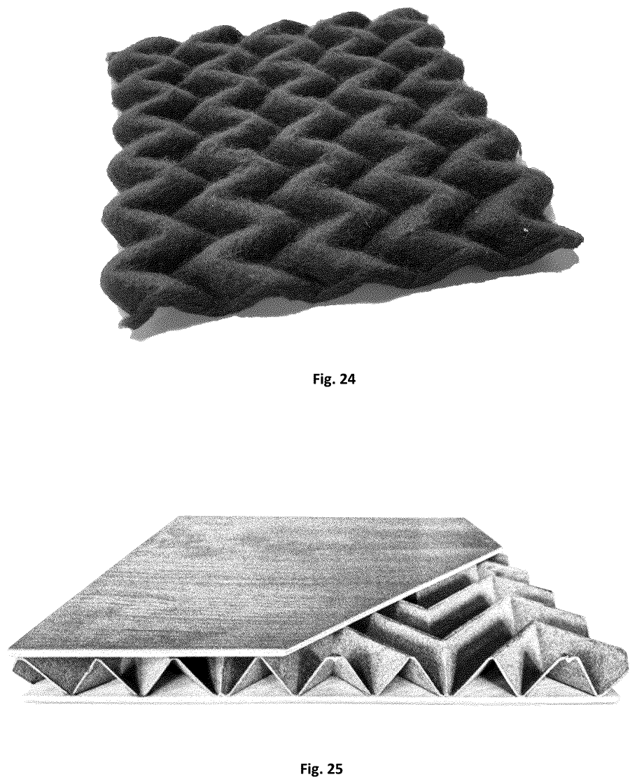

In one embodiment, material is folded and pressed in a tool to impart flat bonding sites for laminate faces. In FIG. 9, for example, the material has been folded and shows a fold radius at the fold creases. This occurs in practice due to the thickness of the material. FIG. 10, by way of example, shows a mating tool that closely resembles the folded pattern, and having flattened plateaus and valleys along the tangent bounding faces. A material similar to FIG. 9 may be placed in the tool similar to FIG. 10 and pressed to produce a part similar to FIG. 11. FIG. 25 shows one embodiment of a material that was folded in an articulating die and then pressed in a tool similar to FIG. 10 and then laminated between two face sheets. In yet a further embodiment, the compression of the material in the tool will increase the density of the stock material. This may assist in enabling less dense materials to be folded and formed and a denser product to be delivered.

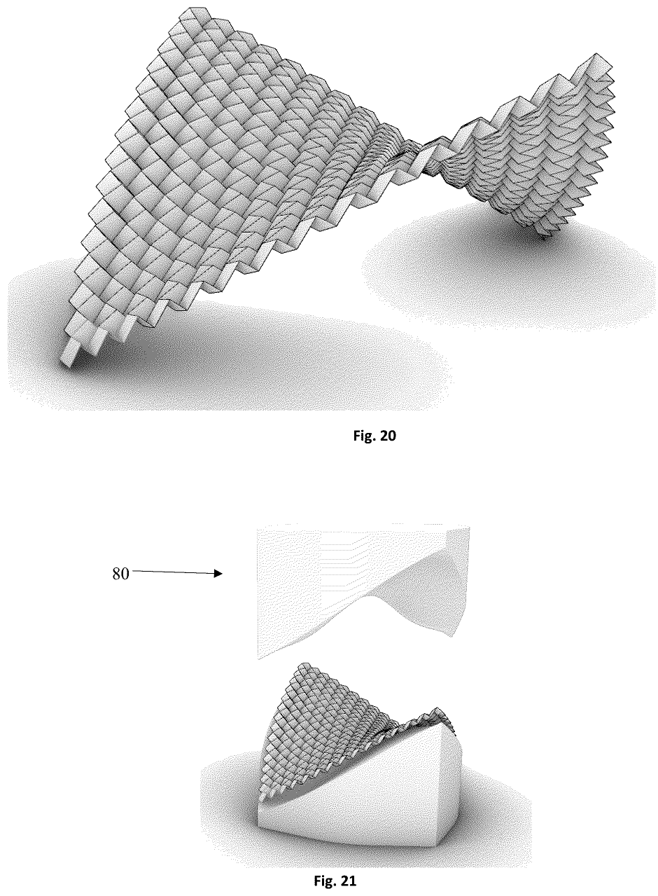

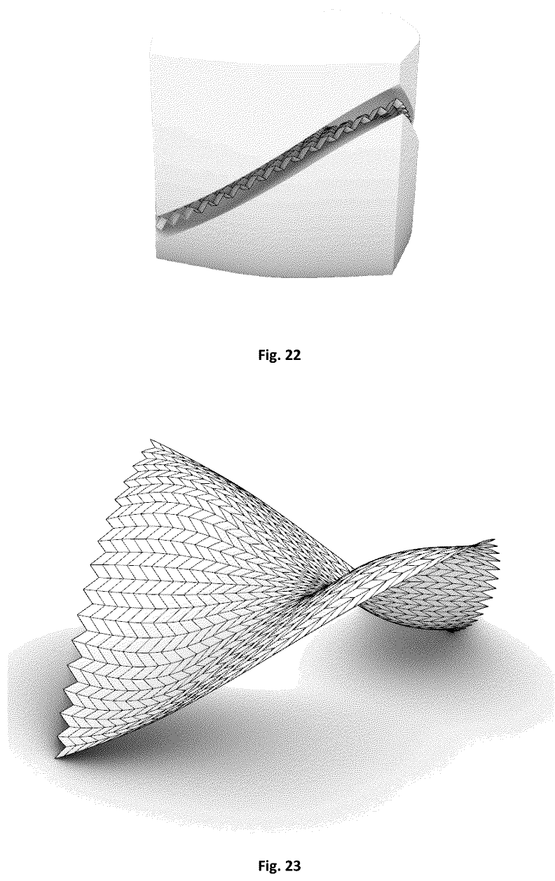

In one embodiment, a tessellation pattern may be folded in a sheet by an articulating die or other means, and then shaped to fit onto a tool by applying a force to the folded material. An embodiment of this invention is shown in several figures. FIG. 19 shows a folded tessellation. FIG. 20 shows the same tessellation after it has been shaped according to one embodiment. FIG. 21 shows the shaped piece of this embodiment conforming to a tool, and FIG. 22 shows the same tool about to compress the tessellated sheet. FIG. 23 shows a schematic drawing of the material in its thin compressed state. Note the crease locations in FIG. 23 are approximate, as in some embodiments the material will crumple as it is pressed in the tool. In one embodiment of the present invention, a thermoplastic felt is folded in an articulating die or by other means to produce a material that may then be formed in a tool. As an example, FIG. 24 is a photograph of a polypropylene felt folded in a pattern similar to FIG. 19. This material is easily reshaped to fit onto a tool and pressed under heat to weld the fibers together into a compressed smooth form. In this embodiment the fold creases may be dispersed into folded fibers and produce a compressed surface without visible crumple lines. Persons skilled in the art will recognize that different tessellations, different shaped tools, and various thermoplastics and polymers may be used without departing from the spirit and scope of the invention.

Another example of the shaping of a sheet may be seen, for example, in FIGS. 9-11. FIG. 9 depicts a folded sheet (60) similar to what may be produced on the articulating die of FIGS. 1-4. The material has a thickness, and this corresponds to the fold radius seen on the crease line (61) in the figure. In one embodiment of the present invention, material is folded in a tessellation pattern and then molded in a tool adapted from the tessellation to have specific geometry that may be needed. In one example of such an embodiment, the tool (80) may have flat regions on the upper and lower tangent faces of the folded pattern, such as illustrated in FIG. 10, where the folded chevron pattern on the underside of the dies (for example, the die as depicted in FIG. 4 or FIG. 6B) is altered to have flat plateaus (81) and valley (82) regions. In this embodiment the material may be pressed after folding it within the strain limitations of the material. In an example of this embodiment, a material similar to FIG. 9 is pressed into a material similar to FIG. 11 with a tool similar to FIG. 10. The strain and deformation of the material is slight, and many foldable materials will accept some deformation. In yet a further embodiment, the material is pressed after folding to produce flat plateaus and valleys where the material is further bonded to laminate face sheets. One embodiment of such post-folding pressing process to produce flat laminate glue areas is shown in FIG. 25.

In another embodiment, sheet materials with thermoplastic binders may be heated prior to folding, folded at elevated temperature, and then cooled. In another embodiment, a thermoplastic felt may be folded and then heat set in the folded state to produce a folded felt now stable in the folded state. One embodiment of the felt material folded in an articulating die and then heat set to hold its folded shape is shown in FIG. 24. This may be used as a precursor in additional tooling and forming process. In a yet further embodiment after folding and heat setting the thermoplastic felt may pressed into a mold or tool. The pre-folded material can stretch readily and will accommodate complex curvatures in the tooling. In another embodiment materials may be folded in a tessellation pattern, and then with or without heat treatment the folded materials compressed in a tool or mold under pressure. In yet a further embodiment the pressure on folded materials will reduce the overall thickness of the tessellation pattern and with thermoplastics, resins or binders will produce a smoother thinner surface. In yet a further embodiment the pressed material will have similar curvatures to the tools or molds used for compression.

In another embodiment the present invention may be incorporated as a component in a laminate assembly. In yet a further embodiment, face sheets may be bonded to the structural material to make a panel.

In one embodiment, the present invention provides a method for making structural material that comprises some or all of the following: an articulating die; a method for transferring force to an articulating die to acuate movement substantially similar to a folding tessellation; hinges between tiles substantially forming a folding tessellation; lever arms; two articulating dies substantially clamping or holding material between them; a heater; a press; a forming tool or mold; a post-folding forming operation in a compression mold; a folding tessellation process followed by a forming process; and a lamination process.

In one embodiment, the present invention provides a structural material that comprises some or all of the following: a folded tessellation; a paper material; a thermoplastic material; a thermoset material; a fibered material; a deformed folded tessellation; a compressed material; design features with formed geometry added to a folded tessellation; flat regions for laminating; compound curvature; laminate face sheet; and a structural panel.

Exemplary characteristics of embodiments of the present invention have been described. However, to avoid unnecessarily obscuring embodiments of the present invention, the preceding description may omit several known apparatus, methods, systems, structures, and/or devices one of ordinary skill in the art would understand are commonly included with the embodiments of the present invention. Such omissions are not to be construed as a limitation of the scope of the claimed invention. Specific details are set forth to provide an understanding of some embodiments of the present invention. It should, however, be appreciated that embodiments of the present invention may be practiced in a variety of ways beyond the specific detail set forth herein.

Modifications and alterations of the various embodiments of the present invention described herein will occur to those skilled in the art. It is to be expressly understood that such modifications and alterations are within the scope and spirit of the present invention, as set forth in the following claims. Further, it is to be understood that the invention described herein is not limited in its application to the details of construction and the arrangement of components set forth in the preceding description or illustrated in the drawings. That is, the embodiments of the invention described herein are capable of being practiced or of being carried out in various ways. All changes which come within the meaning and range of equivalency of the claims are to be embraced within their scope. It is intended to obtain rights which include alternative embodiments to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

The foregoing disclosure is not intended to limit the invention to the form or forms disclosed herein. In the foregoing Detailed Description, for example, various features of the invention are grouped together in one or more embodiments for the purpose of streamlining the disclosure. This method of disclosure is not to be interpreted as reflecting an intention that the claimed inventions require more features than expressly recited. Rather, as the following claims reflect, inventive aspects lie in less than all features of a single foregoing disclosed embodiment. Thus, the following claims are hereby incorporated into this Detailed Description, with each claim standing on its own as a separate preferred embodiment of the invention. Further, the embodiments of the present invention described herein include components, methods, processes, systems, and/or apparatus substantially as depicted and described herein, including various sub-combinations and subsets thereof. Accordingly, one of skill in the art will appreciate that would be possible to provide for some features of the embodiments of the present invention without providing others. Stated differently, any one or more of the aspects, features, elements, means, or embodiments as disclosed herein may be combined with any one or more other aspects, features, elements, means, or embodiments as disclosed herein.

What is claimed is:

1. A method of folding a tessellation with an articulating die, comprising:
hinging the articulating die with a hinge axis patterning substantially similar to the crease lines in a folded tessellation;
providing sheet material in proximity to the contact side of the die; and
applying force to one or more articulating mechanisms on the die, which relay applied force to the folding action of the die, thereby applying corresponding folding action to the sheet material.

2. The method of claim 1, wherein two articulating dies are applied, with said sheet material held between the contact faces of the two dies; and
the dies and material actuated to fold in a press.

3. A method of forming a shaped material, wherein:
an articulating mechanism forms the sheet material into a configuration substantially through a folding tessellation process; and
the material in said configuration is subsequently formed with a compression tool into a material with non-zero Gaussian curvature on vertices or regions.

4. The method of claim 3 wherein the shaped material is further laminated with a face sheet.

5. A structural material with geometry substantially resembling a folded tessellation geometry with additional flattened or compressed deformations regions, wherein:
the intrinsic strain does not exceed the tolerances of the material; and
the average extrinsic displacement from the said folded tessellation geometry to the structural material's geometry is less than the longest polygon edge length of the said folded tessellation.

6. The structural material of claim 5, wherein the structural material has flat bonding sites for laminating face sheet.

7. The structural material of claim 5, wherein the structural material is compressed to have substantially smooth doubly curved regions.
